(19) United States
(12) Patent Application Publication
(10) Pub. No.: US 2005/0125150 A1
(43) Pub. Date: Jun. 9, 2005

(54) Real time control of hardware and software via communications network

(76) Inventors: David Wang, Ontario (CA); Joseph Shu, Westmount (CA); Liya Ni, Ontario (CA); Mauro Rossi, Ontario (CA); Kevin Tuer, Ontario (CA)

Correspondence Address: PEARNE & GORDON LLP, 1801 EAST 9TH STREET, SUITE 1200, CLEVELAND, OH, 44114-3108, US

(21) Appl. No.: 10/496,256

(22) PCT Filed: Nov. 21, 2002
(86) PCT No.: PCT/CA02/01833

(30) Foreign Application Priority Data
Nov. 21, 2001 (CA) 2.363,396

(51) Int. Cl. G01C 21/26

(52) U.S. Cl. 701/213

(57) ABSTRACT

A Hard Real Time Control Center (HRTCC), comprised of hardware, software and firmware, with time synchronisation and time delay compensation methodologies that allows Application Hardware and/or User Input Devices to be networked together on any communications network as if there were negligible network delays in the system, is disclosed. This will allow Application Hardware and/or User Input Devices (connected to an HRTCC at one location (node) on the network) to control or operate Application Hardware and/or User Input Devices connected to another HRTCC at a remote location without the detrimental effects of network time delays. The time synchronisation of the various HRTCCs on the network can be enabled using hardware (e.g. a global positioning system (GPS)) or any other software method (e.g. Network Time Protocol). Using time stamps from the time synchronisation, the time delay of the signals (data) transferred over the network can be determined. The main embodiment of the time delay compensation methodology is an estimator/predictor algorithm. The estimator generates signal information that allows the predictor, using the time delay, to project the signal information characteristics into the future by an amount equal to the time delay. If this predicted signal is used rather than the delayed signal, there will be no readily apparent time delay in the system thereby significantly improving the stability and performance of the associated application. Any software architecture can be used such as servant-client, token ring or peer to peer.

### FIELD OF THE INVENTION

The present invention relates to a hardware/software/firmware platform, which can carry out hard real time control over any network connection including wired/wireless Internet. In hard real time control, it is essential that computations are completed and the results transmitted at set intervals in time called the sampling period as opposed to soft real time control, where results are transmitted whenever particular events are completed. In particular, the invention provides a modular and flexible platform to allow User Input Devices and application devices to communicate and control each other over a communication network, with synchronisation provided by GPS signals or other hardware/software methods. Compensation to predict for network latency is used to maintain performance and stability. The platform can be applied to various applications such as online interactive computer games, networked simulators, telepresence, automated highway systems, remote vehicle control, power system control, telehealth, video surveillance, and telerobotics to name a few.

### BACKGROUND OF THE INVENTION

Presently, application devices and User Input Devices which are connected over networks (e.g. Local Area Networks (LANs), the Internet) are usually under the control of a local computing device (via a Personal Computer (PC), Personal Digital Assistant (PDA) or similar device) with a fixed mechanical panel or PC Graphical User Interface (GUI) as the interface to the human user. There is no attempt to implement hard real time control over the network connection to control another application device or User Input Device at a remote location. This is due, in part, to the inability to properly synchronise the clocks of the computer controllers at two distinct nodes of a network. Synchronisation allows the computers to apply prediction techniques to overcome the time-varying delays over the network.

### SUMMARY OF THE INVENTION

According to one aspect of the present invention, there is provided a Hard Real Time Control Center (HRTCC) for real-time controlling a Application Hardware and associated software and/or a User Input Device over a communications network, a plurality of the Hard Real Time Control Centers each being able to be connected to a node of the communications network. The real time control center comprises: an Application Hardware/Software associated each of the HRTCCs; (b) a User Input Device for controlling an Application Hardware/Software and/or other User Input Devices; (c) a synchroniser for substantially synchronising clocks of the HRTCCs connected to the communications network; (d) a data transmitter for sending data from one HRTCC to another via the communications network; (e) a data receiver for receiving data from other HRTCCs; and (f) an algorithm for determining a time delay incurred during the travel of the data via the communications network, compensating from the determined time delay and providing the compensated data to an Application Hardware and/or a User Input Device, thereby substantially removing the effects of the time delay.

According to another aspect of the present invention, there is provided a Hard Real Time Control Center for real-time controlling a remote or local Application Hardware/Software via a communications network, a plurality of the real time control centers each being able to be connected to a communications network. The Hard Real Time Control Center comprises: (a) a core for controlling the Hard Real Time Control Center; the core including: (i) a CPU; and (ii) a software for mitigating or substantially removing a time-delay effect caused by the communications network; (b) a synchronisation hardware for substantially synchronising clocks of the Hard Real Time Control Centers: (c) a User Input Device for real-time controlling an Application Hardware/Software via a communications network; and (d) an Application Hardware/Software to be controlled by the User Input Device via a communications network; wherein a time-delay effect can be mitigated or removed by said software when all the clocks of the real-time control centers are substantially synchronised.

According to another aspect of the present invention, there is provided a Hard Real Time Control Center (HRTCC) platform for real-time controlling an Application Hardware/Software via a communications network, a plurality of the HRTCC platforms each being connected to a communications network. The HRTCC platform comprises: (a) a synchroniser operatively associated with each platform for substantially synchronising clocks of said platforms; (b) an estimator for estimating data from an Application Hardware/Software of its own, said estimated data being related to operating status of the Application Hardware/Software, said estimated data being transmitted to other platforms via the communications network; and (c) a predictor for determining a time delay of an estimated data transmitted from each of other platforms, compensating for the time delay, which is incurred during the travel of each of said estimated data via the communications network, wherein said compensated data is projected on its own Application Hardware/Software.

According to another aspect of the present invention, there is provided a method of synchronously operating Application Hardware/Software in a plurality of hard real time control systems via a communications network. The method comprises steps of: (a) substantially synchronising clocks of systems, one of the systems being a transmitting side and the other being a receiving side; (b) estimating data from an Application Hardware/Software on the transmitting side, said estimated data being related to operating status of the Application Hardware/Software; (c) determining a time delay, which is incurred by the communications network; (d) compensating the estimated data for the determined time delay; and (e) providing the compensated data to an Application Hardware/Software on the receiving side, whereby the hard real time control systems can be synchronised and a time-delay impact caused by the communications network can be substantially removed.

According to another aspect of the present invention, there is provided a server-client system for operating an Application Hardware/Software via a communications network. The server-client system comprises: (a) a synchroniser for substantially synchronising clocks of a server system and a client system, one of the server and client systems being a transmitting side and the other being a receiving side; (b) an estimator for estimating data from an Application Hardware/Software on the transmitting side, said estimated data being related to operating status of the Application Hardware/Software; and (c) a predictor for determining a time delay incurred during the travel of the estimated data via a communications network, compensating the estimated data for the determined time delay, and providing the compensated data to an Application Hardware/Software on the receiving side, whereby the Application Hardware/Software on the server and client systems can be operatively synchronised.

According to another aspect of the present invention, there is provided a server-client system for real-time controlling a remote or local Application Hardware/Software via a communications network. The server-client system comprises: (a) a server system including a User Input Device for controlling an Application Hardware/Software via a communications network; (b) a client system including the Application Hardware/Software to be controlled by the User Input Device via a communications network; (c) a synchronisation device operatively associated with each of the server system and the client system for substantially synchronising clocks thereof; and (d) a computer program for compensating for a time-delay, which is caused by the communications network, Whereby a synchronised control between the Application Hardware/Software and the User Input Device can be realized.

### BRIEF DESCRIPTION OF THE DRAWINGS

The embodiments of the invention will now be described with reference to the accompanying drawing, in which:

FIG. 1 is a schematic representation of a Hard Real Time Control Center (HRTCC) according to one embodiment of the present invention;

FIG. 2 is a schematic representation of two Hard Real Time Control Centers in a network configuration;

FIG. 3 is a schematic representation of how predictors can be used to compensate for time delays;

FIG. 4 is a schematic representation illustrating how the Kalman Filter Predictor can be broken down into an estimation stage and a prediction stage;

FIG. 5 is a flow chart of the algorithm of the preferred embodiment of the Kalman Filter based Predictor time delay compensation process;

FIG. 6 is a schematic representation of the preferred embodiment of the Random Jerk Model Kalman Filter Predictor in a Server-Client architecture;

FIG. 7 illustrates the impact of using higher order predictor equations such as the Random Jerk Model Kalman Filter Predictor, as compared to the Random Acceleration Model Kalman Filter Predictor and the Linear Dead Reckoning Predictor;

FIG. 8 is a plot comparing the prediction tracking performance of various predictors when there is a one way average time delay of 75 ms in the communication channel and FIGS. 8a and 8b are plots of selected portions of the same;

FIG. 9 is a schematic representation of the Kalman Filter Predictor embodiment in a gaming application in a Server-Client network architecture; and

FIG. 10 is a schematic representation of an alternate embodiment of the Kalman Filter Predictor where the estimator stage and its associated predictor stage are not separated but are co-located at the same node.

### DETAILED DESCRIPTION OF THE PREFERRED EMBODIMENT(S)

In general, the present invention allows the real time control of Application Hardware/Software and/or a User Input Device at one node of a communications network (hereinafter, referred to as the “client”) by a User Input Device and/or Application Hardware/Software at another node (hereinafter, referred to as the “server”). In the invention, it is required that the clocks on both client and server be substantially synchronised, have precise sampling periods and have the ability to perform complex control computations so that a desired effect is enabled at the client end. The invention includes a synchronisation device such as a global positioning system (GPS) receiver or a differential global positioning system (DGPS) receiver or similar hardware/software solutions to accomplish this synchronisation and precision in timing. Also the invention includes sophisticated prediction algorithms such as Kalman Filters in order to advance, in time, the signals transmitted between the client and server (and vice versa) in order to compensate for time-varying network delays caused during the travel of the signals via a communications network. If the prediction is accomplished, the time delays will be transparent to both the server and client systems. This invention is also flexible in that a client can become a server and vice versa, should the need arise.

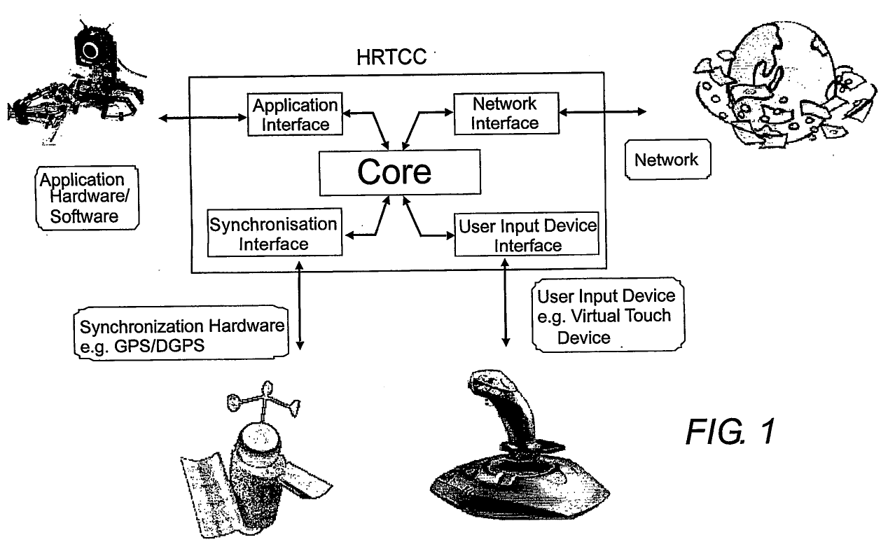

In FIG. 1, there is shown a Hard Real Time Control Center (HRTCC) according to one embodiment of the present invention. As shown in FIG. 1, the Hard Real Time Control Center comprises a Core comprised of hardware, software and a real time operating system, an application Interface, a User Input Device Interface, and a Network Interface. The communications network can include a wired or wireless Internet. The Synchronisation Interface facilitates connection to devices such as a global positioning system (GPS) receiver or a differential global positioning system (DGPS) receiver. The User Input Device Interface facilitates connection to User Input Devices (with or without virtual touch/haptics) such as a reconfigurable panel, to create GUIs where either the client or server Application Hardware/Software can be controlled. The Application Interface facilitates connection to Application Hardware/Software such as remote-controlled robots or Internet computer games.

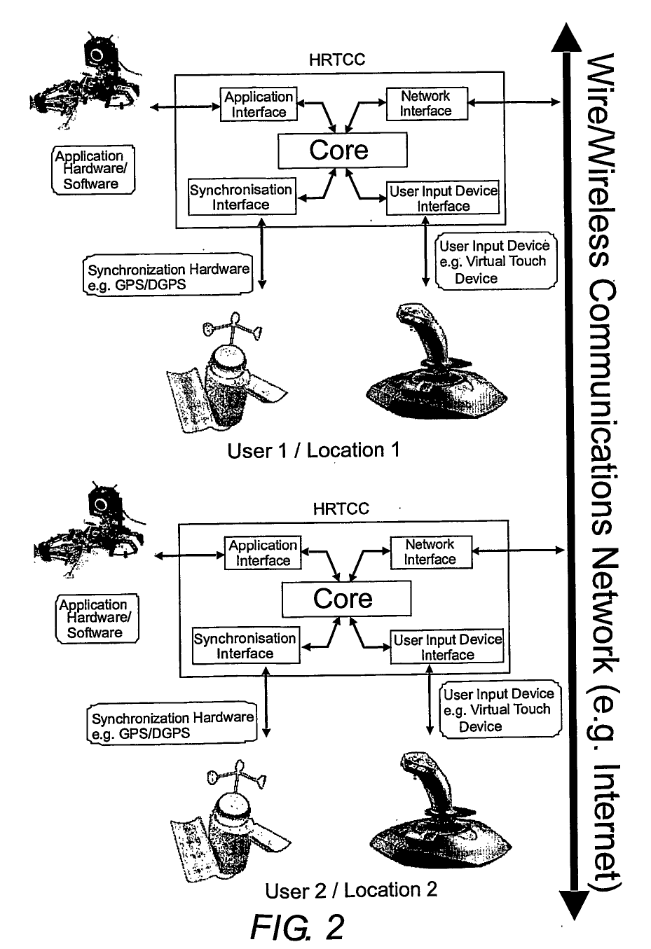

FIG. 2 shows a schematic representation of two Hard Real Time Control Centers in a network configuration. Any number of Hard Real Time Control Centers can be connected to a communications network. The HRTCC can be placed at any node on the communications network, for example, the Internet, to enable real time control of the Application Hardware or the User Input Device hardware such as virtual touch devices at any other node of the Internet, as illustrated in FIG. 2. In this embodiment, the Core can include a modular and robust real time operating system (e.g. QNX, VXWorks or Windows CE, etc.), which is used to enable data transfer and real time control between the Application Hardware and/or the user input hardware, either locally or remotely via the Network Interface. The time delay compensation algorithms (e.g. prediction algorithms) for the network latencies, also reside in the Core. Easily reprogrammable interfaces can be used as the Network Interface, Application Interface, User Input Device Interface, and Synchronisation Interface. These interfaces also include the ability to use existing standardized Application Programming Interfaces (APIs) to communicate with existing Application Hardware, User Input Devices and Synchronisation Interfaces. The User Datagram Protocol (UDP) protocol (or other similar protocol which guarantees speed of data transmission but not necessarily for guaranteed delivery) can be used through the Network Interface.

It is noted that the Application Hardware/Software and the User Input Device hardware can control each other or can be controlled by each other interactively with or without force feedback via the communications network. Therefore, under a certain circumstance, the server can act as a client, and vice versa.

Each component of the HRTCC will be described in greater detail:

Core: The Core comprises a Central Processing Unit (CPU) (or microcontroller or other computational device), a reprogrammable Electronically Erasable Programmable Read Only Memory (EEPROM) (or other similar firmware) and associated software/firmware. A real time operating system may reside on this hardware/firmware. The Core handles the interfacing and exchange of data between the Application Hardware and the User Input Devices, either at the client or server site. As well, it allows the HRTCC to exchange information over the network and to collect GPS/DGPS data in order to synchronise all the HRTCCs on the network. A hardware timer from the GPS receiver can also provide precise signals for the HRTCC if the CPU does not provide sufficient precision. The HRTCC CPU is also responsible for all controller and prediction calculations, as well as any software synchronisation techniques which can be used to replace the GPS hardware synchronisation in applications that do not rely on extremely high precision.

The software synchronisation techniques are techniques that replace the functionality of the GPS (Hardware) synchronisation, which will be described hereinafter in greater detail. One commonly used method is the NTP (Network Time Protocol) where time stamps are exchanged between computers (e.g. between a server and a client) in order to synchronise their clocks. By exchanging sufficient data, it is possible to eventually have the computers' clocks converge. Any other software method of synchronising the computer clocks can also be used.

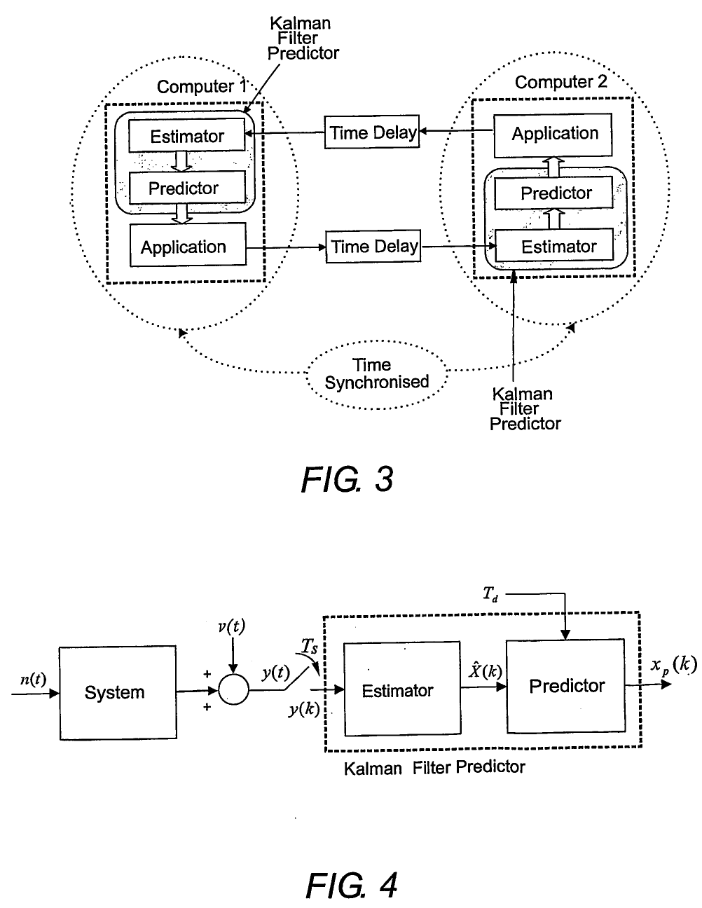

Once all the HRTCCs on the network are synchronised, passive transformation or prediction techniques to remove the time delay effects can be employed. The passive transformation technique transforms signals such that the communication channel is seen as passive, while the predictor compensates for the time delay by using an estimator to get clean kinematic (position, velocity, acceleration, jerk, etc.) values which are then predicted into the future by the same amount of time that was required for the data to be transmitted. This predicted value is then used by the application. This is done in the CPU or microcontroller. FIG. 3 schematically represents how predictors and estimators can be used to compensate for time delays, where the computers 1 and 2 can be a server and a client respectively, or vice versa. In FIG. 3, the dotted lines represent the time synchronisation task, which is done prior to starting the predictor/estimator. Signals are then sent over a time-delayed communication channel, are estimated and then predicted before being sent on to the application.

Three methods of estimating and predicting time-delays are described below, which can be used in various embodiments according to the present invention.

The first method is dead reckoning. This method was initially developed to assist in naval navigation. Basically, an object would be dropped overboard and after a certain amount of time, its position would be determined. From this, the velocity of the ship could be calculated by estimating the time it took for the object to traverse the length of the ship, and using the dead reckoning prediction equations, along with the heading, an estimate of the future position of the ship could be established. In this invention, it is possible to estimate from the time history, the position, velocity and acceleration at the time when the data was transmitted. Once the position, velocity and acceleration are available, it is possible to use the kinematic equations to predict where the system will be in the near future. The key limitation is the necessity for clean signals (low noise levels). This is required because derivatives of the signals must be taken in this algorithm, and noise is amplified significantly when derivative operations are performed. The basic linear dead reckoning equation is as follows:
xₚ(t)=x(t−T_{d})+\dot{x}(t−T_{d})T_{d} (1)
where x(t) is the true signal, xₚ(t) is the estimate of x(t), T_{d} is the time delay, and \dot{x}(t) represents the derivative of x with respect to time. Note that the above prediction equation is linear. However, some dead reckoning algorithms utilise even higher order derivatives (leading to quadratic and cubic prediction equations), but again, taking multiple derivatives will only further amplify the noise. Many modifications to the basic dead reckoning algorithms (e.g. linear/quadratic/cubic spline smoothing and multi-step dead reckoning) can also be used to smooth out the estimates. Another type of dead reckoning that can be used that partially overcomes this noise sensitivity is called Predictive Contracts Dead Reckoning. This method of dead reckoning uses natural language descriptions for anticipating and communicating the states between clients instead of geometric information only. It is noted that T_{d} can only be computed if the clocks of the devices are synchronised.

The second method is the Random Acceleration Model Kalman Filter Predictor. This technique is similar to dead reckoning but it uses a Kalman Filter to generate cleaner position, velocity and acceleration data for the predictor to use in its kinematic prediction. This predictor is based on a model of the signal that is to be transmitted, the Random Acceleration Model. In this model, the first derivative (e.g. the velocity) is assumed constant except for finite time intervals, called manoeuvring times (τ). During the manoeuvring time, the acceleration is bounded, but random. That is, if the signal x(t) represents the position of an object, then the Random Acceleration Model assumes that the object moves with constant speed most of the time, except for short durations where a random acceleration causes the velocity to change. With n(t) and v(t) random white noise signals, the Random Acceleration Model can be represented by the following equation:

$$\frac{ⅆ}{ⅆ t} [ \begin{matrix}x ( t ) \\ \dot{x} ( t ) \\ \ddot{x} ( t )\end{matrix} ] = [ \begin{matrix}0 & 1 & 0 \\ 0 & 0 & 1 \\ 0 & 0 & - 1 / τ\end{matrix} ] [ \begin{matrix}x ( t ) \\ \dot{x} ( t ) \\ \ddot{x} ( t )\end{matrix} ] + [ \begin{matrix}0 \\ 0 \\ 1\end{matrix} ] n ( t ) , \\ y ( t ) = [ \begin{matrix}1 & 0 & 0\end{matrix} ] [ \begin{matrix}x ( t ) \\ \dot{x} ( t ) \\ \ddot{x} ( t )\end{matrix} ] + v ( t ) . \qquad ( 2 )$$

FIG. 4 schematically depicts how the Kalman Filter Predictor can be broken down into an estimation stage and a prediction stage. As illustrated in FIG. 4, the Estimator generates a vector signal X(k) with elements that are estimates of x(k), \dot{x}(k), and \ddot{x}(k) without using derivative operations, thereby avoiding the noise amplification problem faced by the Dead Reckoning methods. The Estimator is updated every Tₛ seconds, so the discrete version of the system model defined in equation (2) can be found as follows;

$$\begin{matrix}{[ \begin{matrix}x ( t ) \\ \dot{x} ( t ) \\ \ddot{x} ( t )\end{matrix} ]}_{k + 1} = {[ \begin{matrix}1 & {T}_{s} & {τ}^{2} ( {ⅇ}^{- {T}_{s} / τ} + {T}_{s} / τ - 1 ) \\ 0 & 1 & τ ( 1 - {ⅇ}^{- {T}_{s} / τ} ) \\ 0 & 0 & {ⅇ}^{- {T}_{s} / τ}\end{matrix} ] [ \begin{matrix}x ( t ) \\ \dot{x} ( t ) \\ \ddot{x} ( t )\end{matrix} ]}_{k} + {[ \begin{matrix}{n}_{1} \\ {n}_{2} \\ {n}_{3}\end{matrix} ]}_{k} & ( 3 ) \\ := {A}_{e} {x}_{d} ( k ) + n ( k ) , & \end{matrix}$$

y(k)=[1 0 0]x_{d}(k)+v(k):=Cₑx_{d}(k)+v(k). (4)
Let us define positive definite symmetric matrices Q and R that represent the state noise covariance matrix and the measurement noise covariance matrix, respectively. Then the Estimator is given by the following equations:

$$K ( k ) = {A}_{e} P ( k ) {{C}_{e}^{T} [ {C}_{e} P ( k ) {C}_{e}^{T} + R ]}^{- 1} , \\ \hat{X} ( k + 1 ) = {A}_{e} \hat{X} ( k ) + K ( k ) [ y ( k ) - {C}_{e} \hat{X} ( k ) ] , \\ P ( k + 1 ) = {A}_{e} P ( k ) {A}_{e}^{T} + Q - K ( k ) [ {C}_{e} P ( k ) {C}_{e}^{T} + R ] {K ( k )}^{T} . \qquad ( 5 )$$

It is noted that since the Estimator input is the time delayed data, \hat{X}(k) is a vector that contains elements that are estimates of x(ξ), \dot{x}(ξ), \ddot{x}(ξ), where ξ:kTₛ−T_{d} and k is a positive integer. The elements of \hat{X}(k) will be denoted \hat{x}(ξ),\hat{\dot{x}}(ξ),\hat{\ddot{x}}(ξ). The initial conditions for the algorithm are \hat{X}(0)=\hat{X}₀ and P(0)=P₀. Moreover, these estimates are less susceptible to noise since the optimal filter gives the minimum variance estimate of the state. The Predictor can thus utilise the estimates of the higher order derivatives in generating the estimate of the true signal. The predictor equation is given by

$$\begin{matrix}{x}_{p} ( t ) = [ 1 {T}_{d} {τ}^{2} ( {ⅇ}^{- {T}_{d} / τ} + {T}_{d} / τ - 1 ) ] \hat{X} ( k ) \\ = \hat{x} ( t - {T}_{d} ) + {T}_{d} \dot{\hat{x}} ( t - {T}_{d} ) + \frac{{T}_{d}^{2}}{2} \ddot{\hat{x}} ( t - {T}_{d} ) + ϑ ( {T}_{d}^{3} ) .\end{matrix} \qquad ( 6 )$$

In fact, the predictor equation of the Random Acceleration Kalman Filter Predictor is a generalisation of the basic Dead Reckoning prediction equation as can be seen by the first two terms (constant velocity/linear dead reckoning) or by the first three terms (constant acceleration/quadratic dead reckoning) in the equation (6).

The third method is called the Random Jerk Model Kalman Filter Predictor. It is noted that the “jerk” of the signal is the fourth derivative of position with respect to time, or alternately, the time derivative of the acceleration. Like the Random Acceleration Model Kalman Filter Predictor, the Random Jerk Model Kalman Filter Predictor can be broken down into two parts:
a) The Estimator provides filtered versions of the position, velocity, acceleration and jerk.
b) The Predictor projects the position estimate T_{d} seconds into the future based on the estimated velocity, acceleration, and jerk.

The Estimator is designed based on a Random Jerk Model that can be represented by the following model:

$$\begin{matrix}\frac{ⅆ}{ⅆ t} [ \begin{matrix}x ( t ) \\ \dot{x} ( t ) \\ \ddot{x} ( t ) \\ {x}^{...} ( t )\end{matrix} ] = [ \begin{matrix}0 & 1 & 0 & 0 \\ 0 & 0 & 1 & 0 \\ 0 & 0 & 0 & 1 \\ 0 & 0 & 0 & - \frac{1}{τ}\end{matrix} ] [ \begin{matrix}x ( t ) \\ \dot{x} ( t ) \\ \ddot{x} ( t ) \\ {x}^{...} ( t )\end{matrix} ] + [ \begin{matrix}0 \\ 0 \\ 0 \\ 1\end{matrix} ] {n}_{1} ( t ) , & ( 7 ) \\ y ( t ) = [ \begin{matrix}1 & 0 & 0 & 0 \\ 0 & 1 & 0 & 0 \\ 0 & 0 & 1 & 0 \\ 0 & 0 & 0 & 1\end{matrix} ] [ \begin{matrix}x ( t ) \\ \dot{x} ( t ) \\ \ddot{x} ( t ) \\ {x}^{...} ( t )\end{matrix} ] + [ \begin{matrix}0 \\ 0 \\ 0 \\ 1\end{matrix} ] {n}_{2} ( t ) , & ( 8 )\end{matrix}$$

where x(t) is the position, n₁(t) and n₂(t) are white noise inputs and τ is a manoeuvring time variable. In this case, if the signal x(t) represents the position of an object, then the Random Jerk Model assumes that the object moves with constant acceleration most of the time, except for short durations where a random jerk causes the acceleration to change. The discrete version of the Random Jerk Model is given as follows:

$$\begin{matrix}\begin{matrix}{[ \begin{matrix}x ( t ) \\ \dot{x} ( t ) \\ \ddot{x} ( t ) \\ {x}^{...} ( t )\end{matrix} ]}_{k + 1} = {[ \begin{matrix}1 & {T}_{s} & {T}_{s}^{2} / 2 & {τ}^{3} [ 1 - {T}_{s} / τ + {T}_{s}^{2} / ( 2 {τ}^{2} ) - {ⅇ}^{- {T}_{s} / τ} ] \\ 0 & 1 & {T}_{s} & {τ}^{2} [ {ⅇ}^{- {T}_{s} / τ} - 1 + {T}_{s} / τ ] \\ 0 & 0 & 1 & τ [ 1 - {ⅇ}^{- {T}_{s} / τ} ] \\ 0 & 0 & 0 & {ⅇ}^{- {T}_{s} / τ}\end{matrix} ] [ \begin{matrix}x ( t ) \\ \dot{x} ( t ) \\ \ddot{x} ( t ) \\ {x}^{...} ( t )\end{matrix} ]}_{k} + {[ \begin{matrix}{\hat{n}}_{1} \\ {\hat{n}}_{2} \\ {\hat{n}}_{3} \\ {\hat{n}}_{4}\end{matrix} ]}_{k} \\ = {A}_{e} {x}_{d} ( k ) + n ( k ) ,\end{matrix} & ( 9 ) \\ y ( k ) = [ \begin{matrix}1 & 0 & 0 & 0 \\ 0 & 1 & 0 & 0 \\ 0 & 0 & 1 & 0 \\ 0 & 0 & 0 & 1\end{matrix} ] {x}_{d} ( k ) + v ( k ) = {C}_{e} {x}_{d} ( k ) + v ( k ) . & ( 10 )\end{matrix}$$

Another assumption made here, as seen in equations (8) and (10), is that the first three derivatives of x are available to the Estimator. In this embodiment, the derivatives of the system are measurable (Cₑ=I). This means that derivatives of x are necessary. It is however noted that noise is not an issue here since the Kalman filter will minimize the noise and the Predictor will be using the filtered estimates. Let us define positive definite symmetric matrices Q and R that represent the state noise covariance matrix and the measurement noise covariance matrix, respectively. The Estimator equations used here are now the same as those found in equation (5), but using the matrices defined in equations (9) and (10) for Aₑ and Cₑ. The initial conditions for the algorithm are \hat{X}(0)=\hat{X}₀ and P(0)=P₀.

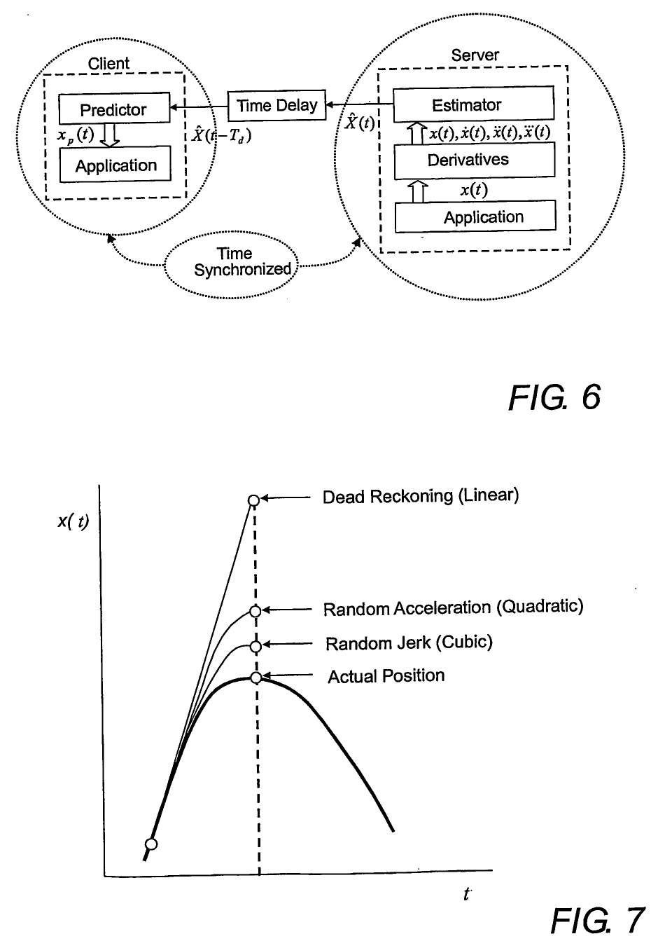

Since with time varying time delay communication channels data can be out of order or lost, the output of the communication channel will seem noisier than the input to the communication channel. Hence it is better to run the Estimator on the server with the cleaner input and transmit the output of the Estimator to the client. This means that the Kalman Filter has less noise input, which results in better estimates. This configuration is schematically illustrated in FIG. 6.

The Predictor takes the output of the Estimator, after it has been transmitted, and projects it T_{d} seconds into the future. The following equation represents the predictor equation:

$$\begin{matrix}{x}_{p} ( t ) = \hat{x} ( t - {T}_{d} ) + {T}_{d} \dot{\hat{x}} ( t - {T}_{d} ) + \frac{1}{2} {T}_{d}^{2} \ddot{\hat{x}} ( t - {T}_{d} ) + \\ {τ}^{3} [ 1 - {T}_{d} / τ + {T}_{d}^{2} / ( 2 {τ}^{2} ) - {ⅇ}^{- {T}_{d} / τ} ] {\hat{x}}^{…} ( {t}_{1} ) \\ = \hat{x} ( {t}_{1} ) + {T}_{d} \dot{\hat{x}} ( {t}_{1} ) + \frac{1}{2} {T}_{d}^{2} \ddot{\hat{x}} ( {t}_{1} ) + \frac{1}{6} {T}_{d}^{3} \ddot{\hat{x}} ( {t}_{1} ) + ϑ ( {T}_{d}^{4} ) .\end{matrix} \qquad ( 11 )$$

It is noted that linear dead reckoning methods only use the first two terms found in the above equation and that the Random Acceleration Model Filter Predictor uses the first three terms found in the above equation.

As presented to this point, data is transmitted from the server to the client every sample period. While this results in the best prediction performance, this may not be desirable from a bandwidth perspective, so a method of trading off performance for reduced bandwidth is now presented. Suppose the client's application contains a model of the user's motion at the server (i.e. given only a few inputs, the client can estimate the position of the user at the server location by using the embedded model). Then the server can send out fewer updates and the client would be responsible for estimating the position of the user at the server when new updates are not available.

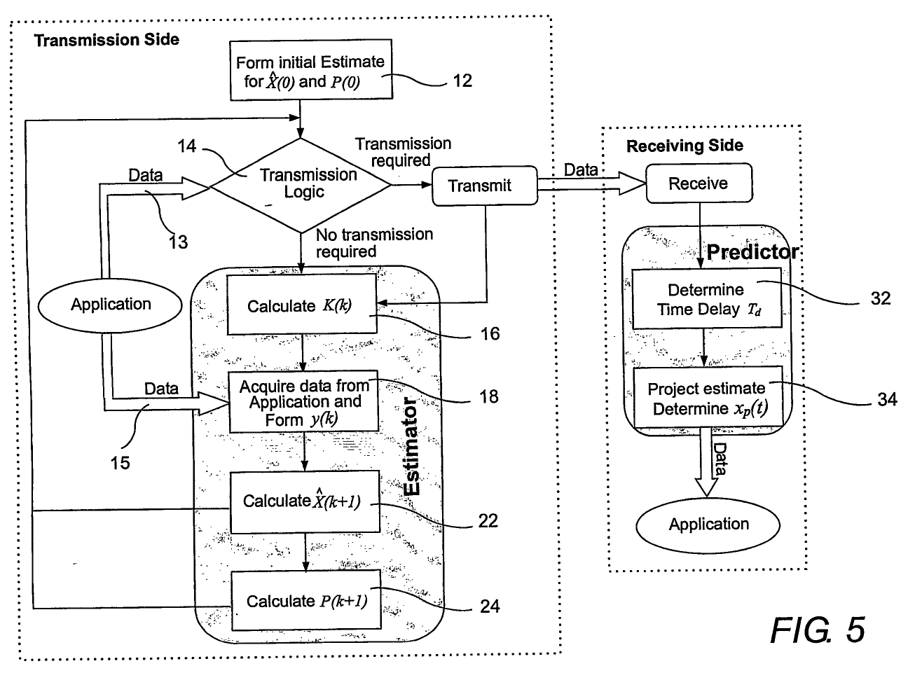

FIG. 5 is a flow chart of the algorithm of the preferred embodiment of the Kalman Filter based Predictor time delay compensation process and it is now applied to the Random Jerk Model Kalman Filter Estimator and Predictor Algorithm. Referring to FIG. 5, the basic steps taken by the Random Jerk Kalman Filter Predictor are described below.
a) The application on the transmitting side provides data to the estimator. It is noted that the data from the application is related to the operating status of the application and thus can include kinematic information, which changes with respect to time, such as an operating position.
b) The estimator filters the data (i.e. generates estimates of velocity, acceleration, jerk) and then makes it available to the transmission logic.
c) The transmission logic determines if an update is necessary based on performance and bandwidth criteria. If an update is necessary, then data from the estimator is transmitted to the receiving side.
d) Data is received at the receiving side after a certain time delay.
e) Since the transmitting side and receiving side are synchronised, it is possible to determine the time delay.
f) Knowing the time delay and the kinematic data that has been received, the predictor is able to compensate for the time delay by projecting the data into the future the same amount of time that the data was delayed.

More details of the Random Jerk Kalman Filter Estimator & Predictor algorithm will be presented as follows:

FIG. 5 illustrates the logic used to implement the Random Jerk Kalman Filter Estimator and Predictor. During the initialization on the receiving side (or client side), at step 14, the communication channel is checked to see if data has been received. If not, then the receiving side waits until data is available. During the initialization on the transmission side (at step 12), an initial estimate of the position, velocity, acceleration, and jerk (i.e. \hat{x}(0),\hat{\dot{x}}(0),\hat{\ddot{x}}(0), [symbol] (0)) is determined and the vector \hat{X}(0)=[\hat{x}(0) \hat{\dot{x}}(0) \hat{\ddot{x}}(0) [symbol] (0)]^{T} is formed. An initial estimate of the prediction error covariance matrix P(0) is also formed during the initialization. If it is not possible to analytically determine P(0), then it is possible to choose P(0)=λI where λ is a scalar initial weighting constant and I is an identity matrix of appropriate dimensions.

At step 14, the transmission logic (14) determines if data should be sent to the receiving side. Depending upon the overall application, an initial update could be sent immediately, or data could be held until an update is required, as defined in the following logic. Embedded within the transmission logic and the application on the receiving side are identical models of the signal x(t). The model in the transmission logic uses a snapshot of the data (at step 13) as an input, and outputs a signal \tilde{x}(t). The model within the transmission logic only uses the information that is available to the receiving side application, so the signal \tilde{x}(t) generated in the transmission logic is identical to the \tilde{x}(t) generated at the receiving side application. Therefore, the transmission logic is aware of the receiving side's perceived position x(t), namely \tilde{x}(t), as well as the actual position x(t). It is however noted that disturbances are not modeled, so if a disturbance is introduced on the transmission side through the application (e.g. a user applies a random input), then x(t) will deviate from \tilde{x}(t). Therefore, when the difference between the perceived and actual positions (i.e. x(t) and \tilde{x}(t)) exceeds a pre-defined threshold, then a new update is required on the receiving side and data is transmitted. The data transmitted includes a time stamp, the current position, velocity, acceleration and jerk. With this new update, the embedded model within the transmission logic and the receiving side's application is reset and the process is repeated. By incorporating this transmission logic, fewer updates are required and therefore the bandwidth requirement is reduced.

After the transmission logic has completed its tasks, given the measurement covariance matrix R, the Kalman gain K(k) can be calculated (at step 16) using equation (5). Following this, the transmission side application provides data updates (at step 15), including the current position, velocity acceleration and jerk, to form the vector y(k) (at step 18) as defined in equation (10). Then given these values of K(k) and y(k), the updated estimate \hat{X}(k+1) (at step 22) and updated covariance matrix P(k+1) (at step 24) can be calculated using equation (5). These updates are then used in the next iteration of the algorithm, where k is incremented by 1.

On the receiving side, once data has been received (at step 32) the time delay can be determined by subtracting the current time on the receiving side computer from the time stamp on the data packet, since the two sides are time synchronised. Given this calculated time delay T_{d} and the delayed version of the position x(t−T_{d}), velocity \dot{x}(t−T_{d}), acceleration \ddot{x}(t−T_{d}), and jerk [symbol] (t−T_{d}), the prediction of the position xₚ(t) can be calculated (at step 34) using equation (11) and then passed on to the receiving side application.

The logic illustrated in FIG. 5 only shows data being transferred in one direction, but if bilateral communication is required then each node in the network will require the transmission side logic as well as the receiving side logic.

Generally speaking, the Random Jerk Model Kalman Filter Predictor uses a cubic equation for prediction, where the Random Acceleration Model Kalman Filter Predictor only uses a quadratic equation, and the Dead Reckoning Predictor is typically limited to using a linear equation. The extra degree of the predictor equation allows for more accurate predictions. This is illustrated in FIG. 7, which schematically illustrates the impact of using higher order predictor equations such as the Random Jerk Model Kalman Filter Predictor, as compared to the Random Acceleration Model Kalman Filter Predictor and the Linear Dead Reckoning Predictor. It should also be noted that the data transmission between the nodes can be asynchronous. This is useful since sending out data only when it is needed will save on bandwidth requirements.

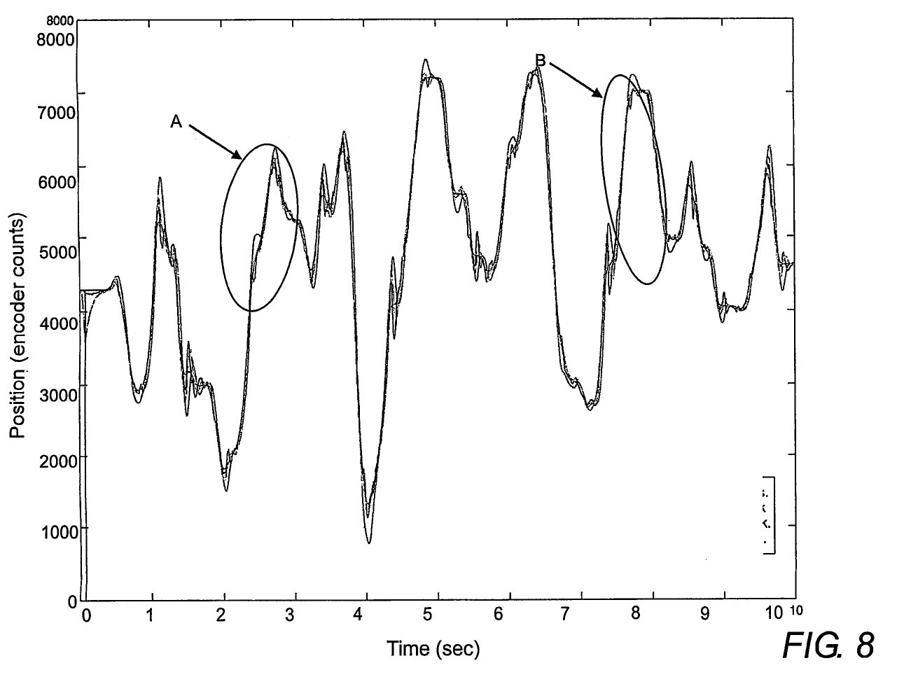

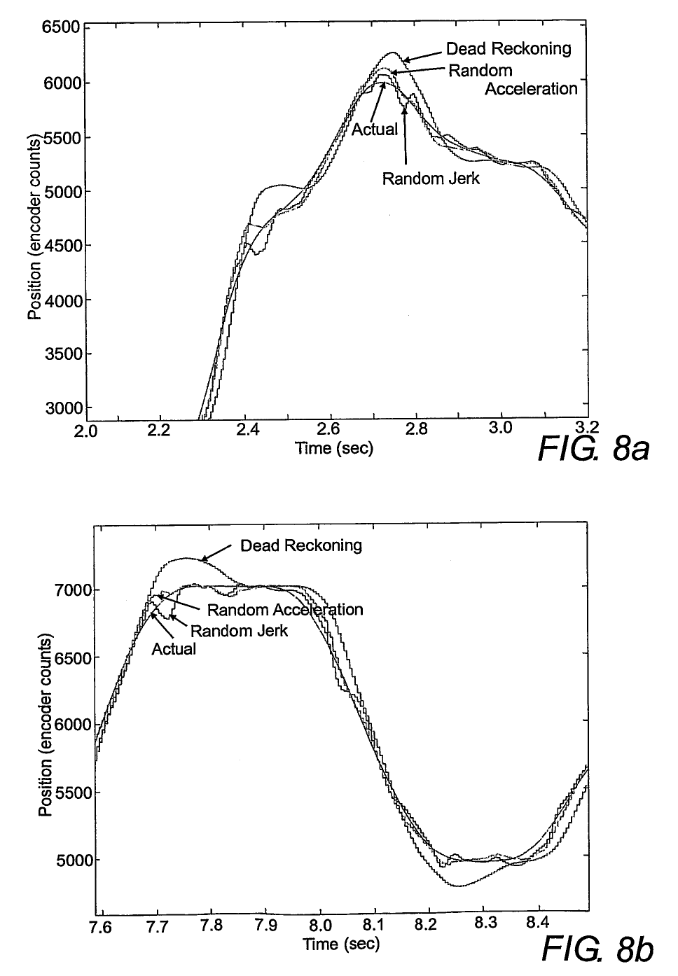

To evaluate and compare the Random Jerk Model Kalman Filter Predictor to other algorithms, a sample of data was collected from a user's random computer mouse motion and the information was transmitted from one computer to another through communication network with a one way time varying time delay with a mean of 75 ms. The prediction results of the Random Jerk Model Kalman Filter Predictor are compared to the Random Acceleration Model Predictor and Dead Reckoning Predictor in FIG. 8. FIGS. 8a and 8b are enlarged presentations of the portions A and B respectively in FIG. 8. The signal represents the x position of the mouse in encoder counts. Clearly the Random Jerk Model Kalman Filter Predictor shows less overshoot especially when a change in direction is made by the user.

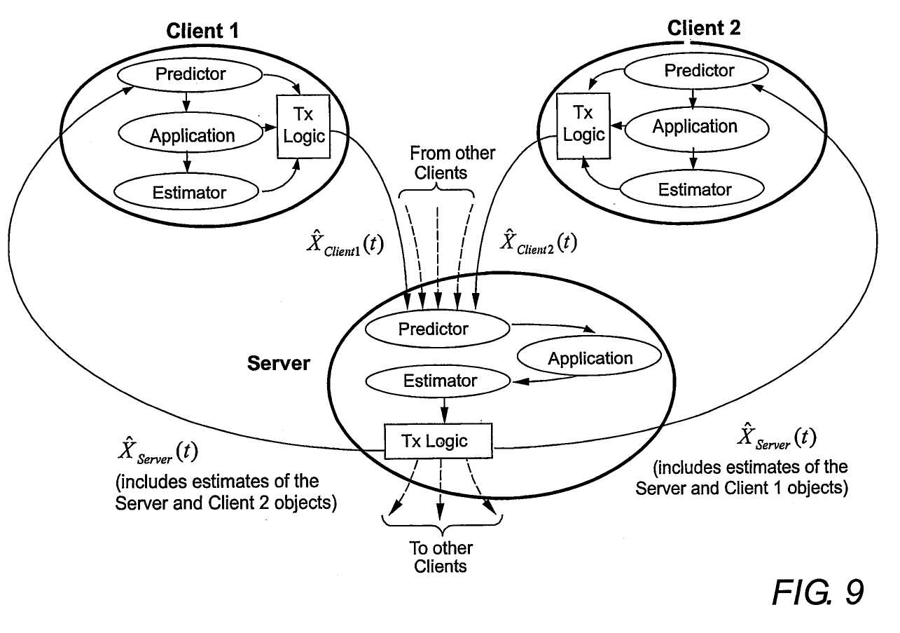

FIG. 9 is a schematic representation of one embodiment of the present invention, where the Kalman Filter Estimator and Predictor algorithm is implemented in a server-client network architecture such as in a Internet gaming application. The server and the clients have synchronised clocks, and the synchronisation is accomplished via software or hardware methods. One player would act as the server and all the remaining players would act as clients. Each player has control of an associated game object (e.g. a car, an aircraft, etc.) as well as a model of the gaming environment (e.g. road barriers, missiles, etc.).

Referring to FIG. 9, details of this embodiment will be described below.
a) The server intermittently sends data (\hat{X}_{Server}(t) via the server transmission logic) associated with the status of all the other player's objects, to the client's predictor. Clarification as to when data is sent will become apparent in the step (i).
b) The purpose of the client's predictor is to compensate for the time delay incurred during the transmission of the data, and in doing so, to provide the client's application with estimates of the location of each player's object. The predictor equation and the logic were described earlier by equation (11) and FIG. 5.
c) The client's application provides data associated with the client's object to the client's estimator. Models of the other players' objects are also incorporated into the client's application, so that estimates of the other players' position between updates can be determined.
d) The client's estimator then filters the signal and passes it to the client's transmission logic in preparation to transmit it back to the server. The estimator equations and logic were described earlier by equation (5) and FIG. 5.
e) The client's transmission logic (denoted “Tx Logic” in FIG. 9) also has a model of its own object that is used by every other player to estimate the position of the client's position between updates. The transmission logic compares the position estimate obtained by the model to the actual position supplied by the application. If the difference between the actual position and the model output is greater than some threshold (i.e. the position perceived by other players does not match well with the actual position), then an update is required and the transmission logic transmits the client's estimator output to the server's predictor. The purpose of this transmission logic is to reduce the amount of data that needs to be transmitted to the Server, and hence reduce the bandwidth and computational effort required at the server.
f) When data is received at the server from a client, the server's predictor compensates for the time delay of the received data and then passes that prediction to the server's application. The predictor equation and the logic were described earlier by equation (11) and FIG. 5.
g) The server's application then updates a global status of all the players. Like the clients, the server's application also has a model of each player, so that estimates of each player can be determined between updates. The server application also provides this global status to the server estimator.
h) The server's estimator then generates kinematic estimates and passes them to the server's transmission logic in preparation to transmit it out to the clients. The estimator equations and logic were described earlier by equation (5) and FIG. 5.
i) The reception of an update from one client acts as the trigger in the server's transmission logic to send an update to all the other clients' predictors.

The above steps (a) to (i) describe how data transfer between a client and server is accomplished. If data from client 2 is needed by client 1, data is first transferred from client 2 to the server, and then client 1 can obtain the client 2 data from the server.

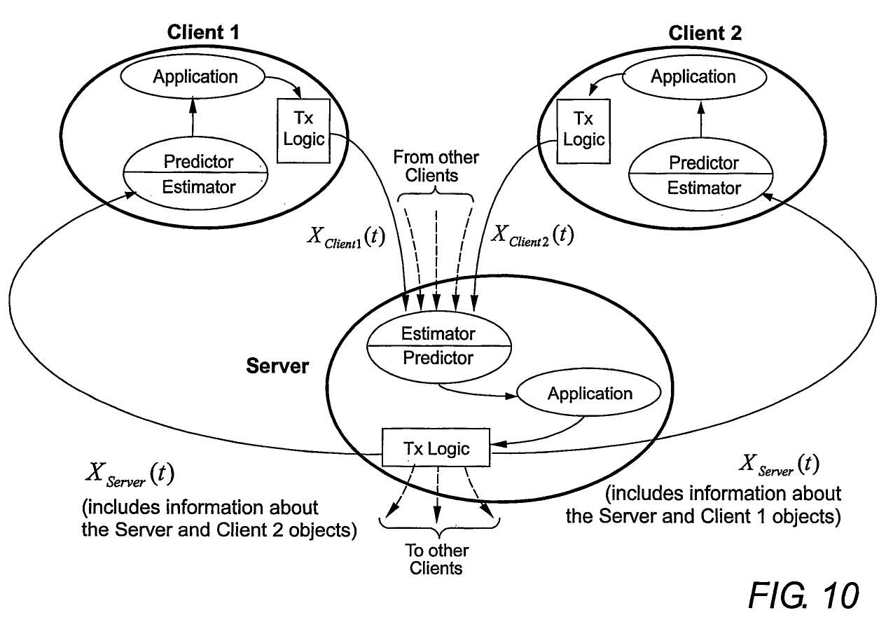

Although these are three possible predictive techniques, this invention encompasses all other similar prediction techniques. Some examples of extensions and/or simplifications for the preferred embodiment are as follows:
a) Extending the Random Jerk Model to higher derivatives (e.g. include the derivative of the jerk into the model) could result in even better prediction results, but at a cost of more computations.
b) The separation of the predictor and the estimator stages of the Random Jerk Model Kalman Filter Predictor (e.g. FIG. 6) is not necessary (e.g. FIG. 3). An alternate embodiment showing the estimator and associated predictor stages remaining together for the Internet game application is illustrated in FIG. 10. It should be noted that in FIG. 10, the estimator at each client needs to estimate the position for every other client. In FIG. 9, however, the estimator at each client only needs to estimate its current position. This means that in the configuration illustrated in FIG. 9, more calculations are passed off to the server.
c) The computer architecture mentioned up to this point has been server-client. The invention could be applied to any network architecture (e.g. peer-to-peer, token-ring). For each network architecture, the partitioning of the estimators and predictors for each Random Jerk Kalman Filter Predictor can be performed as shown in FIG. 9, or they can be kept together as shown in FIG. 10.
d) The input of the estimator described in the preferred embodiment contained position, velocity, acceleration as well as jerk. For large scale systems/networks, where there are many signals, bandwidth could suffer if all the higher derivatives need to be transmitted as well. In an alternate embodiment, only the position needs to be transmitted and the estimator can be designed with a single input instead of multiple inputs. For example, in the Random Jerk Model found in equation (10), Cₑ=[1 0 0 0] can be used instead of Cₑ=I
e) Using a different Random Model could also result in better tracking performance for specific applications. For example the Random Walk Velocity Model,

$${\frac{ⅆ}{ⅆ t} [ \begin{matrix}x ( t ) \\ \dot{x} ( t )\end{matrix} ]}^{′} = [ \begin{matrix}0 & 1 \\ 0 & 0\end{matrix} ] [ \begin{matrix}x ( t ) \\ \dot{x} ( t )\end{matrix} ] + [ \begin{matrix}0 \\ 1\end{matrix} ] n ( t ) \qquad ( 12 )$$
or the Random Velocity Model,

$$\frac{ⅆ}{ⅆ t} [ \begin{matrix}x ( t ) \\ \dot{x} ( t )\end{matrix} ] = [ \begin{matrix}0 & 1 \\ 0 & - 1 / τ\end{matrix} ] [ \begin{matrix}x ( t ) \\ \dot{x} ( t )\end{matrix} ] + [ \begin{matrix}0 \\ 1\end{matrix} ] n ( t ) \qquad ( 13 )$$
or the Random Walk Acceleration Model,

$$\frac{ⅆ}{ⅆ t} [ \begin{matrix}x ( t ) \\ \dot{x} ( t ) \\ \ddot{x} ( t )\end{matrix} ] = [ \begin{matrix}0 & 1 & 0 \\ 0 & 0 & 1 \\ 0 & 0 & 0\end{matrix} ] [ \begin{matrix}x ( t ) \\ \dot{x} ( t ) \\ \ddot{x} ( t )\end{matrix} ] + [ \begin{matrix}0 \\ 0 \\ 1\end{matrix} ] n ( t ) \qquad ( 14 )$$
or any further extension of these models could be used to design the estimator. Some models will be more appropriate for an application than others.
f) In some applications, the higher order derivatives of the signal can be measured (e.g. accelerometer sensors are used), so taking derivatives may not be necessary.
g) Instead of using prediction technology an alternate time delay compensation strategy called wave variable transformations can be used. Wave variable transformations are applied to signals prior to transmission and after reception to ensure that the communication channel remains passive. When the communication channel appears passive, then the system appears to have its signals put through an equivalent set of capacitors, resistors and inductors. In other words, there are no active components in the system which might input energy into the system to cause it to go unstable. By ensuring that the communication channel is passive, a passive control algorithm can be used on each computer so that theoretical guarantees can be made on the overall stability of the system. Note however that these transformations are very conservative and require the time delay to be constant, so the resulting system performance is typically poor.
h) The characteristics of the communication network may change over time, and an alternate embodiment of the predictor would be to adaptively change the parameters of the estimator and predictor to account for those changes. For example, the measurement covariance matrix may be different at different times of the day. Hence, it would be advantageous to choose the most appropriate matrix based on the time of day that the application is running.
i) In some applications, hard real time control may not be required. Hence, an alternate embodiment would be to use a soft real time or event based system.

Network Interface: This interface contains all hardware (e.g. FPGAs: Field Programmable Gate Arrays) and software for converting the data from the Core to the appropriate format/protocol for transmission over the Internet (or other telecommunications networks), and vice versa. This interface will be made modular so that all common protocols (Transmission Control Protocol/Interface Protocol (TCP/IP), User batagram Protocol (UDP), Wireless Application Protocol (WAP), etc.) can be supported. As well, the ability to support local wireless formats such as Bluetooth could also be included.

Synchronisation Interface: The synchronisation hardware (a hardware timer) supplies the source of accurate time information to the interface, which, in turn, outputs an interrupt to the Core to provide absolute accuracy to within a fraction of a millisecond for the HRTCC.

The synchronisation hardware such as a GPS receiver or atomic and other high precision clocks can supply accurate time that is agreed upon anywhere in the world. Computers that have access to any of these hardware timers can get the current absolute time from the timers and use it as an internal timer for synchronisation purposes. The current embodiment of this invention uses the global positioning system (GPS) receiver and a differential global positioning system (DGPS) receiver as the synchronisation hardware. However any other kind of hardware timers can be used in place of the GPS or DGPS receiver.

Accurate timing information in the order of nanoseconds (traceable to the Universal Coordinated Time (UTC), the world standard time) can be obtained from GPS receivers. The design of the GPS requires that receivers anywhere in the world are able to generate a very accurate time that is maintained by the atomic clocks on the GPS satellites. To provide this accurate timing information, each GPS receiver has a dedicated signal called Pulse-Per-Second (PPS) that is active every second, right on the second. Since PPS signals are generated at the exact time (accurate to sub-millisecond accuracy) anywhere in the world, the server and client computers can both wait for the PPS signal as an indication to start the internal timer on both computers. The server and client computers can resynchronise their clocks with subsequent PPS signals since the clocks inside ordinary computers tend to drift quickly due to the low quality clock crystals.

There are many different ways to interface with GPS receivers. GPS receivers come in various configurations depending on the integration requirements. The current implementation to interface with the computer running the HRTCC is through the serial port. The PPS signal coming out of the receiver serial port has a pulse length on the order of a microsecond, which is too short for the computer serial port to capture it. A special circuit utilizing an RS-latch is used to capture the PPS signal from the receiver and hold it long enough so that the computer can recognize and process the signal. Other ways of interfacing GPS receivers with the computers, e.g., PCI or ISA GPS boards that are inserted into the computer expansion slots, can also be used.

The present implementation of the synchronisation method requires two PPS signals to initialize. The first PPS signal directs the computers to acquire the current absolute time from the receivers. The absolute time acquired from the GPS is stored locally in the computer memory and is updated every sampling period. This timer value is then used to timestamp the data packets that get sent out through the communication link. Due to the fact that the response time for acquiring the absolute time from the receiver is lengthy (on the order of tens of milliseconds) and varying, a second PPS is needed to signal the start of the control process on both server and client computers. Since PPS is signaled right on the second, it is therefore necessary to adjust the internal timer to align to the second once the second PPS is detected.

The above operation sequence is only one example of achieving synchronisation. The current invention includes any other methods in achieving time synchronisation.

Application Interface: This can be a microcontroller or microprocessor which takes signals from the Core and converts them into a form (Voltage, current, Pulse Width Modulation (PWM) signal, etc.) which can be used by the actuators on the Application Hardware. It also converts sensor signals from the Application Hardware (encoder readings, digital signals, analog signals, etc.) into a form usable by the Core. For example, the Application Hardware could be the graphical display for a computer game, or an automobile in an automated highway system, or a surgical robot in a telehealth application.

User Input Device Interface: The User Input Device Interface, comprised of both hardware and software, can be a microcontroller or microprocessor which takes signals from the Core and converts them into a form specific to the user input hardware or software such as a virtual touch device. It supports both off-the-shelf and custom User Input Devices. It also converts sensor signals from the User Input Device into a form usable by the Core. Unlike the Application Interface, the User Input Device Interface would not necessarily send/read raw signals to/from the actuators/sensors (e.g. current to a motor, encoder reading for a motor), but would send/read data directly from the User Input Device such as a conventional or virtual touch device (e.g. desired motor position, force sensed on a joystick).

Various applications of the present invention and their associated advantages will be described below.

1. Online interactive computer games: Online computer games, which involve multi-users competing with each other over the Internet, presently have very limited force interaction between the players. According to the present invention, real-time force effects can be transmitted with accurate time synchronisation between the users. For example, in a combat game between several users, it is essential that all the contact forces be felt with appropriate magnitudes and in the proper sequence. As well, it is possible to have a main server accomplishing the bulk of the complicated force and prediction computations, thus using a thin client model to enable force-reflecting online computer games. A thin client on a network relies on having most of the functionalities of the system being in the server on the network.

2. Networked simulators: A similar application to that of the online games is networked simulators. Virtual Reality simulators are currently run by a computer located at the same geographical site. Network time delays create problems when Virtual Reality simulators at remote sites are connected together in one virtual environment. If the avatars (human operated virtual objects) from different simulators interact, the time delays creates overshoot and, in the case of haptic effects, can create dangerous oscillations. This invention removes the time delay artifacts and allows the human users at remote locations to interact as if they were connected to computers located at the same geographical location. This technology thus supports initiatives involving Distributed Virtual Environments (DVE).

3. Telepresence: With the capabilities of this invention, it is feasible to immerse a user in a remote environment over the Internet with the ability to see, hear and touch. The user sits in a local site with VR goggles (or similar gear) and interfaces to a virtual touch device which imparts force sensations on the user, and a GUI. At the remote location, there is a mobile vehicle or device with a stereo pair of cameras and another virtual touch device attached to it. The local user can then control the remote mobile vehicle using the HRTCC. The stereo camera tracks the current location of the VR goggles (even with the presence of time delays) and relays the video back to the VR goggles. Finally, the HRTCC is also used so that the user can touch objects using the remote virtual touch device, even in the presence of time delays. In this way, the user, for example, has an enhanced sense of reality of being at the remote site.

4. Automated Highway Systems (AHS): Using the software/hardware/firmware platforms which are currently in use in telematics applications along with the hard real time control technology of the invention, it can be possible to enable many functionalities in an AHS. This is because it is now possible for one vehicle to control another vehicle on the highway and it is also possible to have a server control, in real time, all vehicles on a highway. In this way, cars could autonomously be driven as if there were a virtual towbar between them, creating smaller spacing between vehicles and thus increasing efficiency. It is possible to have collision avoidance where, in the event of an accident, a server could immediately plot out safe braking strategies (e.g. having a car between two semi trailers is disastrous unless all vehicles stop at virtually the same rate) or trajectory changes. This would also be useful for law enforcement as it will be possible to safely take over control of a stolen vehicle or a vehicle being driven by an impaired individual. The police officer can drive the vehicle to a safe location.

5. Remote vehicle control: It should be noted that the invention can also be extensively applied to a host of vehicle control situations including land vehicles, airborne vehicles, and amphibious vehicles. The HRTCC platform will provide the user the ability to remotely pilot these vehicles with the use of touch where applicable. For instance, a pilot situated in an air traffic control tower could be given the ability to take over control of a hijacked aircraft and fly it to safety. In addition, the controls in the air traffic control tower could be given the sense of touch to emulate the forces on the actual aircraft controls.

6. Power system control: In these days of deregulation, it is becoming more important in complex power systems that resources are managed efficiently and that power flows are not disrupted. However, to do this, many sophisticated control algorithms that have been proposed assume that a disruption at one part of the power network can be compensated for at another part of the network. The HRTCC could be employed so that the node where disruption has occurred can control other devices at other parts of the network in order to reduce the possibility of blackouts, brownouts or total voltage collapse.

7. Telehealth: A number of telehealth initiatives can benefit from the HRTCC technology including telesurgery, telementoring, telestration and telepalpation. In each case, a health care professional (HCP) is given the ability to control a device over a network to interface, with or without the sense of touch, with a patient. In the case of telesurgery, the HCP controls a remote robot to perform a surgical procedure. In the case of telementoring, a HCP teaches a remote colleague, using a device enabled with the sense of touch, a procedure such as insertion of a catheter through an arterial network or a surgical procedure. In the case of telestration, a HCP can aid a remote colleague in performing a procedure via real time mark up of camera images. In the case of telepalpation, a HCP can control a remote device to palpate a patient. All of these applications can be enabled using the HRTCC platform.

8. Video surveillance: Often, video surveillance is employed by systematically recording and monitoring a host of remotely installed stationary cameras. Using the HRTCC, these cameras can be upgraded to include pan-tilt motion and a user will be able to access and control any camera on the network in real time. If a situation is unfolding, the user will be able to slew the relevant cameras in real time to capture evidence that is often out of range of stationary cameras.

9. Telerobotics: Telerobotics in general will benefit from the use of the HRTCC platform for applications such as mine clearing, bomb clearing, reconnaissance, remote maintenance tasks (such as those in hazardous areas), control of a mining robot, etc. In all cases, a user is able to remotely control a robot to perform the desired task with the added benefit of being able to touch and feel the environment.

While the present invention has been described with reference to specific embodiments, the description is illustrative of the invention and is not to be construed as limiting the invention. Various modifications may occur to those skilled in the art without departing from the true spirit and scope of the invention as defined by the appended claims.

1-58. (canceled)

59. A network system for implementing hard real time control through a communications network, comprising:
a plurality of control systems, the control systems being capable of communicating with each other through the communications network,
each of the control systems including:
one or more interfaces for application hardware and associated software and/or a user input device;
a synchronizer for substantially synchronizing clocks of the control systems;
a transmitter for sending data associated with the application hardware and associated software and/or the user input device to one or more control systems via the communications network;
a receiver for receiving data from one or more control systems via the communications network; and
compensating means for compensating the received data for a time delay associated with a transmission via the communications network to remove an effect of the time delay for the hard real time control; and
means for providing the compensated data to the interface to operate the application hardware and associated software and/or the user input device.

60. A network system according to claim 59, wherein the compensating means includes predicting means for predicting current data associated with the received data.

61. A network system according to claim 60, wherein the compensating means includes:
an estimator for estimating data from the application hardware and associated software and/or the user input device, the estimated data being related to operating status of the application hardware and associated software and/or the user input device; and
a predictor for projecting the estimated data into current data to operate its own application hardware and associated software and/or the user input device in hard real time.

62. A network system according to claim 60, wherein the user input device connected to at least one of the control systems includes a haptic device, a user of the haptic device interacting an object through the communication networks and receiving haptic effect.

63. A network system according to claim 59, wherein the time delay includes a time-varying delay.

64. A network system according to claim 59, wherein the compensating means is adapted to carry out a dead reckoning prediction process, a Random Acceleration Kalman Filter prediction process, a Random Jerk Kalman Filter prediction process, a higher order Random Movement Kalman Filter prediction process or combinations thereof.

65. A network system according to claim 59, wherein at least one of the control system includes a transmission logic for determining whether or not to send data to other control systems, depending on the operating status of the application hardware/software of the control systems.

66. A network system according to claim 61, wherein one of the control systems acts as a server platform and the others act as client platforms, wherein all the client platforms send their estimated data to the server platform and the server platform distributes the estimated data to the client platform.

67. A network system according to claim 59, wherein the synchronizer includes a global positioning system (GPS) receiver, or a differential global positioning system (DGPS) receiver, a hardware time source, a software time source or a combination thereof.

68. A network system according to claim 59, wherein the data contains a time stamp.

69. A method of implementing hard real time control in a network system, the network system including a plurality of hard real time control systems, each of which has an application hardware/software and is capable of communicating with each other via a communications network, the method comprising steps of:
substantially synchronizing clocks of the hard real time control systems, one of the hard real time control systems being a transmitting side and the other being a receiving side;
estimating data from an application hardware/software on the transmitting side, the estimated data being related to operating status of the application hardware/software;
determining a time delay associated with a transmission via the communications network;
compensating the estimated data for the time delay to remove an effect of the time delay for the hard real time control; and
providing the compensated data to an application hardware/software on the receiving side for the hard real time control.

70. A method according to claim 69, wherein the compensating step includes the step of predicting current data based on the estimated data.

71. A method according to claim 70, wherein the application hardware/software of at least one of the hard real time control systems includes a haptic device, and the providing step includes the step of providing haptic effect to a user of the haptic device in response to the compensated data

72. A method according to claim 69, further comprising a step of:
determining whether or not to send data of the transmitting side to the receiving side, depending on the operating status of the application hardware/software of both sides.

73. A method according to claim 69, wherein the estimating step includes a step of generating kinematic information, the kinematic information being associated with the data and being time-varying.

74. A method according to claim 73, wherein the kinematic information includes a velocity information, and acceleration information, a jerk information and/or combinations thereof.

75. A method according to claim 69, wherein the compensating step carries out a dead reckoning prediction process, a Random Acceleration Kalman Filter prediction process, a Random Jerk Kalman Filter prediction process, a higher order Random Movement Kalman Filter prediction process or combinations thereof.

76. A server-client system for implementing a hard real time control between server and client systems via a communications network, the server-client system comprising:
a synchronizer for substantially synchronizing clocks of the server system and the client system, one of the server and client systems being a transmitting side and the other being a receiving side;
an estimator for estimating data from an application hardware/software on the transmitting side, the estimated data being related to operating status of the application hardware/software; and
a predictor for determining a time delay of the estimated data associated with a transmission via the communications network, and compensating the estimated data for the determined time delay for the hard real time control, and
means for providing the compensated data to an application hardware/software on the receiving side.

77. A server-client system according to claim 76, further comprising a transmission logic for determining whether or not to send data of the transmitting side to the receiving side, depending on the operating status of the application hardware/software of both sides.

78. A server-client system according to claim 76, wherein the application hardware/software on one of the transmitting and receiving sides includes a user input device for controlling the operation of the application hardware/software on the other side.

79. A server-client system according to claim 78, wherein the user input device includes a haptic device, a user of the haptic device operating the application hardware/software through the communications network, and receiving haptic effect.

80. A server-client system according to claim 77, wherein the time delay includes a time-varying delay.

81. A server-client system for implementing hard real time control via a communications network, the server-client system comprising:
a server system including a user input device for controlling an application hardware/software via the communications network;
a client system including the application hardware/software to be controlled by the user input device via the communications network;
a synchronization device operatively associated with each of the server system and the client system for substantially synchronizing clocks thereof; and
compensating means for compensating data transmitted between the server system and the client system for a time delay associated with the transmission via the communications network for the hard real time control between the application hardware/software and the user input device.

82. A server-client system according to claim 81, wherein the compensating means includes predicting means for predicting current data associated with data received at the server or the client through the communications network.

83. A server-client system according to claim 82, wherein the user input device includes a haptic device, a user of the haptic device operating the application hardware/software through the haptic device and receiving haptic effect.

84. A server-client system according to claim 81, wherein the time delay includes a time-varying delay.

85. A server-client system according to claim 81, wherein the application hardware/software can be interactively communicated with and force-interactively controlled by the user input device.

86. A server-client system according to claim 81, wherein the compensating means is adapted to carry out a dead reckoning prediction process, a Random Acceleration Kalman Filter prediction process, a Random Jerk Kalman Filter prediction process, a higher order Random Movement Kalman Filter prediction process, and/or combinations thereof.
